(19) United States
(12) Patent Application Publication
(10) Pub. No.: US 2025/0249729 A1
(43) Pub. Date: Aug. 7, 2025

(54) VEHICLE EXTERIOR COMPONENT

(71) Applicant: TOYODA GOSEI CO., LTD., Kiyosu-shi (JP)

(72) Inventors: Motoki KUBOTA, Kiyosu-shi (JP); Koji FUKAGAWA, Kiyosu-shi (JP); Yuki OGAWA, Kiyosu-shi (JP); Moriyuki HASHIMOTO, Kiyosu-shi (JP)

(21) Appl. No.: 19/019,673

(22) Filed: Jan. 14, 2025

(30) Foreign Application Priority Data
Feb. 1, 2024 (JP) 2024-014284

(51) Int. Cl. B60H 1/22; B60R 13/00

(52) U.S. Cl. CPC B60H 1/2227; B60R 13/00; B60H 2001/2293

(57) ABSTRACT

A vehicle exterior component includes a heater portion including a sheet base made of a plastic and a heating wire, a connector portion that is made of a plastic and is joined to the sheet base, and a base made of a plastic. The base is molded integrally with the heater portion and the connector portion. The connector portion includes a tubular housing having an open first end and a second end that is embedded in the base. A part of the housing that is embedded in the base includes a projection that projects from an outer peripheral surface of the housing. End faces on one side and an other side of the projection in the axial direction are joined to the base.

### CROSS-REFERENCE TO RELATED APPLICATIONS

This application is based upon and claims the benefit of priority from Japanese Patent Application No. 2024-014284, filed on Feb. 1, 2024, the entire contents of which are incorporated herein by reference.

### BACKGROUND

### 1. Field

The present disclosure relates to a vehicle exterior component.

### 2. Description of Related Art

A typical electromagnetic wave transmissive cover is disposed forward of a radar device. The electromagnetic wave transmissive cover includes a plastic cover base, a heater film disposed adjacent to the rear surface of the cover base, and a connector joined to the heater film.

The cover base is integrally molded with the heater film and connector through insert molding, in which the heater film and connector are used as inserts.

The connector includes a plastic connector housing to which a connector of a device for supplying electric power to the heater film (hereinafter, referred to as a mating connector) is connected.

In such an electromagnetic wave transmissive cover, part of the connector housing is embedded in the cover base, allowing the connector to be supported by the cover base.

In related-art vehicle exterior components having such heater films, when a mating connector is connected to the connector housing, the connector housing receives a load, for example, in the axial direction or the circumferential direction of the connector housing. At this time, the stress resulting from the load concentrates at the interface between the connector housing and the cover base. As a result, the connector may be detached from the cover base.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a heater portion, a connector portion, and a base. The heater portion that includes a sheet base made of a plastic and a heating wire that is held by the sheet base and generates heat when energized. The connector portion is made of a plastic. The connector portion is joined to the sheet base. The base is made of a plastic. The base is molded integrally with the heater portion and the connector portion by using the heater portion and the connector portion as inserts. The connector portion includes a tubular housing having an open first end and a second end that is embedded in the base. A direction along an axis of the housing is defined as an axial direction of the housing. A part of the housing that is embedded in the base includes a projection that projects from an outer peripheral surface of the housing. End faces on one side and an other side of the projection in the axial direction are joined to the base.

Other features and aspects will be apparent from the following detailed description, the drawings, and the claims.

### BRIEF DESCRIPTION OF THE DRAWINGS

FIG. 1 is a front view of an electromagnetic wave transmissive cover as an embodiment of a vehicle exterior component.

FIG. 2 is a perspective view mainly showing a connector portion of the electromagnetic wave transmissive cover shown in FIG. 1.

FIG. 3 is a cross-sectional view taken along line 3-3 of FIG. 2.

FIG. 4 is a perspective view showing a heater portion, a terminal portion, and the connector portion of the embodiment.

FIG. 5 is a perspective view of FIG. 4 as viewed from the opposite side.

FIG. 6 is a cross-sectional view taken along line 6-6 of FIG. 2.

FIG. 7 is a cross-sectional view taken along line 7-7 of FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

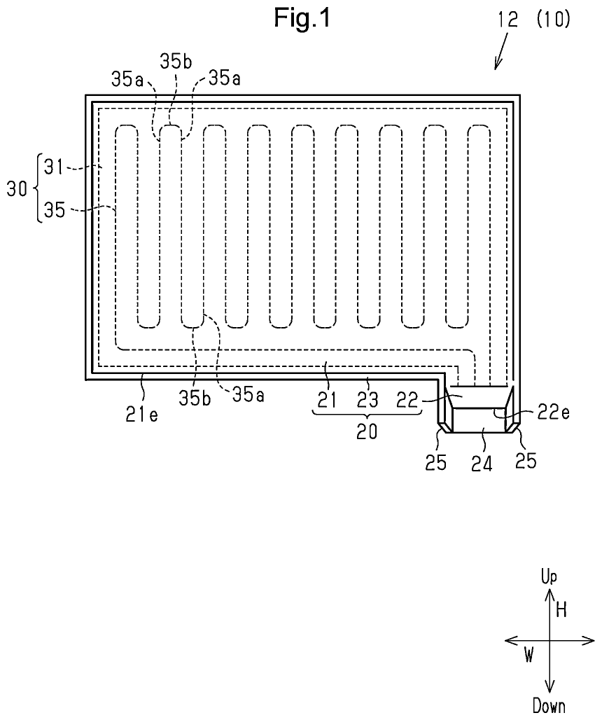

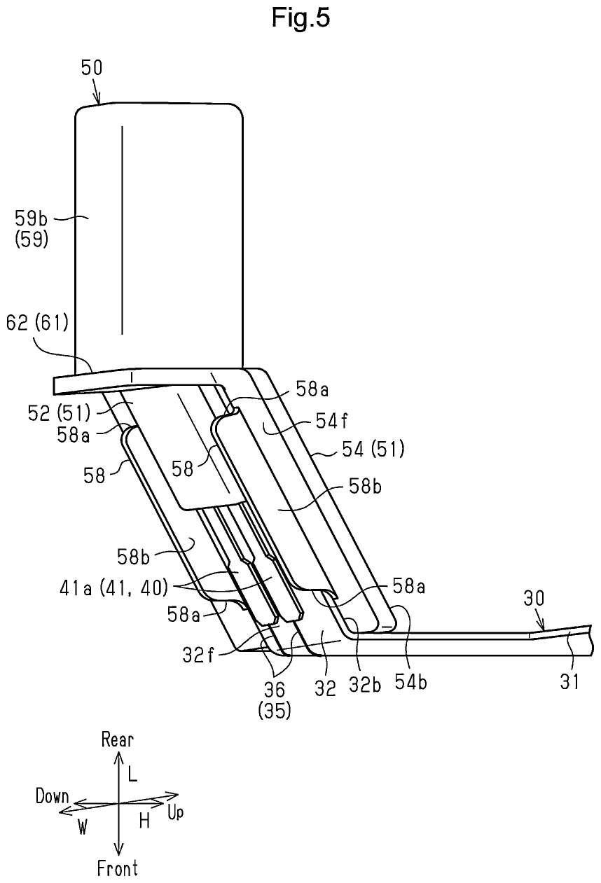

A vehicle exterior component according to an embodiment will now be described with reference to FIGS. 1 to 7. In the present embodiment, the present disclosure is embodied as an electromagnetic wave transmissive cover 12 provided at the front portion of a vehicle 10.

The longitudinal direction of the vehicle 10 will hereafter be referred to as a longitudinal direction L, and “front” and “rear” in the longitudinal direction L will simply be referred to as “front” and “rear”. The width direction of the vehicle 10 will simply be referred to as the vehicle width direction W. The vertical direction of the vehicle 10 when the vehicle 10 is on a horizontal plane will be simply referred to as a vertical direction H, and the ‘upward’ and ‘downward’ in the vertical direction H will simply be referred to as the ‘upward’ and ‘downward’, respectively.

As shown in FIGS. 1 to 3, a radar device 11 is disposed at the front portion of the vehicle 10. The radar device 11 is a vehicle on-board sensor that emits and receives electromagnetic waves for detecting objects outside the vehicle 10. The radar device 11 emits electromagnetic waves having a wavelength of 1 mm to 10 mm and a frequency of 30GHz to 300 GHz, or millimeter waves. In the present embodiment, the emission direction of the millimeter waves of the radar device 11 agrees with the longitudinal direction L.

An electromagnetic wave transmissive cover 12 (hereinafter, simply referred to as a cover 12) is disposed forward of the radar device 11.

The cover 12 forms a part of an outer shell of the vehicle 10 at the front portion of the vehicle 10, and includes a base 20, a heater portion 30, two terminal portions 40, and a connector portion 50.

Each component will now be described.

### Base 20

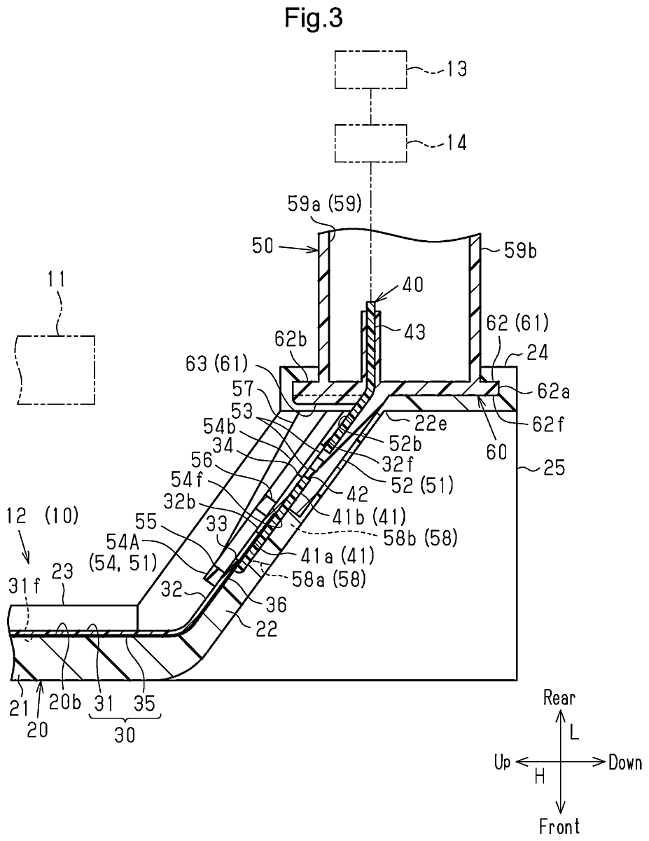

As shown in FIG. 3, the base 20 is formed of a plastic and has millimeter wave transparency.

Examples of the plastic forming the base 20 include polyolefin plastics such as polyethylene (PE) and polypropylene (PP), acrylic plastics such as acrylonitrile-butadiene-styrene copolymer (ABS) plastic, acrylonitrile-ethylene-styrene copolymer (AES) plastic, acrylonitrile-styrene-acrylate copolymer (ASA) plastic, and polymethyl methacrylate plastic (PMMA), and thermoplastics such as polycarbonate (PC). Two or more of the above-mentioned plastics may be used in combination. In the present embodiment, the base 20 is formed of an ABS plastic.

As shown in FIGS. 1 to 3, the base 20 includes a cover main body 21, an extension 22 partially extending from an edge 21e of the cover main body 21, and a frame 23 extending along the edges 21e and 22e of the cover main body 21 and the extension 22.

### Cover Main Body 21

The cover main body 21 is a main part of the cover 12. The cover main body 21 has the shape of a rectangular plate having a pair of long sides arranged in the vertical direction H and a pair of short sides arranged in the vehicle width direction W in a front view (see FIG. 1). In the present embodiment, the cover main body 21 is disposed so as to be orthogonal to the longitudinal direction L at the foremost position in the cover 12 (see FIG. 3).

### Extension 22

The extension 22 extends rearward, bending from the edge 21e of the cover main body 21.

The extension 22 is inclined with respect to the longitudinal direction L. Specifically, the extension 22 is angled downward as it extends toward the rear (see FIG. 3).

Hereinafter, for illustrative purposes, one side (a side facing forward and downward) in the thickness direction of the extension 22 will be referred to as the “front”, and the other side (a side facing rearward and upward) will be referred to as the “rear”.

### Frame 23

As shown in FIGS. 1 to 3, the frame 23 is provided over the entire edges 21e, 22e of the cover main body 21 and the extension 22.

A part of the frame 23 that surrounds the extension 22 is formed by a first wall portion 24 connected to the rear end of the extension 22 and two second wall portions 25 connected to the opposite ends of the extension 22 in the vehicle width direction W.

### Heater Portion 30

As shown in FIGS. 1 to 3, the heater portion 30 heats the cover main body 21, and includes a sheet base 31 joined to a rear surface 20b of the base 20, and a heating wire 35 that generates heat when energized. The entire heater portion 30 has millimeter wave transparency.

### Sheet Base 31

As shown in FIG. 3, the sheet base 31 is a sheet made of a plastic. Examples of the plastic forming the sheet base 31 include the same plastics as those exemplified for the base 20. The plastic forming the sheet base 31 is preferably the same as the plastic forming the base 20 from the viewpoint of the degree of surface contact with the base 20. In the present embodiment, the sheet base 31 is formed of an ABS plastic.

The main part of the sheet base 31 is joined to the cover main body 21. On the other hand, a part of the sheet base 31 (hereinafter, referred to as a sheet extension 32) extends along the extension 22.

The sheet extension 32 includes a pair of openings 33 and a pair of openings 34. The openings 33 and the openings 34 are spaced apart from each other in the direction in which the sheet extension 32 extends.

### Heating Wire 35

The heating wire 35 is formed by a resistance wire, which is a conductive wire such as a nichrome wire that generally has a high electrical resistance.

As shown in FIG. 3, the heating wire 35 is held by the sheet base 31 in a state of being embedded in a front surface 31f of the sheet base 31. The heating wire 35 is routed in a specified wiring pattern in the front surface 31f. In the present embodiment, as shown in FIG. 1, the heating wire 35 is routed in a wiring pattern having multiple linear portions 35a extending parallel to each other and multiple connecting portions 35b connecting ends of the linear portions 35a adjacent to each other.

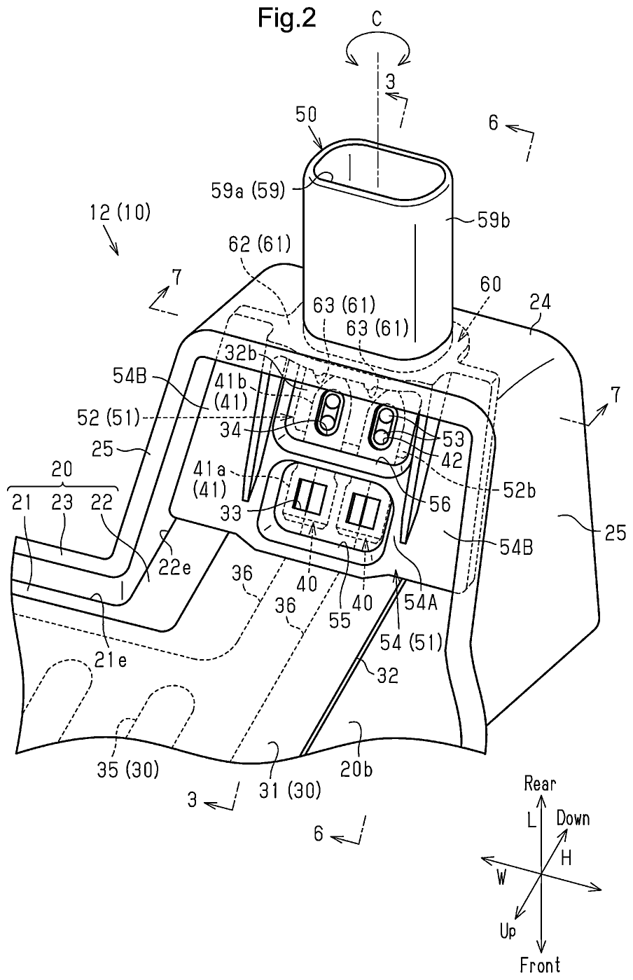

As shown in FIGS. 2 and 3, two end portions 36 of the heating wire 35 in the extending direction are located in the sheet extension 32. The end portions 36 are spaced apart from each other in the vehicle width direction W and extend parallel to each other along the extension 22.

### Terminal Portions 40

As shown in FIGS. 2 and 3, the two terminal portions 40 are formed from a conductive material, such as metal, and are identical in shape. Henceforth, the description will focus on one terminal portion 40; the other will not be discussed.

The terminal portion 40 includes a first connecting portion 41, which extends along the extension 22, and a second connecting portion 43, which extends rearward in the longitudinal direction L, bending from the rear end of the first connecting portion 41 (see FIG. 3).

The first connecting portion 41 is disposed forward of the sheet extension 32. A front section 41a of the first connecting portion 41 is electrically connected to an end portion 36 of the heating wire 35. The front section 41a is joined to the end portion 36 from behind using a known method such as fusing, soldering, or crimping. The joint of the front section 41a and the end portion 36 is exposed rearward through an opening 33 of the sheet extension 32.

A rear section 41b of each first connecting portion 41 includes a connection hole 42, which is continuous with an opening 34, at a position corresponding to the opening 34.

A connector (hereinafter, referred to as a mating connector 14) of a device 13 for supplying electric power to the heating wire 35 is electrically connected to the second connecting portions 43 (see FIG. 3).

Each terminal portion 40 is formed by, for example, punching a metal plate into a specified shape and then bending the metal plate.

### Connector Portion 50

As shown in FIGS. 3 to 5, the connector portion 50 is made of an electrically insulative plastic. In the present embodiment, the connector portion 50 is formed of an AES plastic.

The connector portion 50 includes a terminal holding portion 51, which fixes the terminal portions 40 to the heater portion 30, and a housing 59, into and from which the mating connector 14 is inserted and removed.

### Terminal Holding Portion 51

The terminal holding portion 51 holds the terminal portion 40 and is joined to the sheet extension 32 of the sheet base 31.

The terminal holding portion 51 includes a front holding portion 52 and a rear holding portion 54. The rear holding portion 54 is arranged on the opposite side of the sheet extension 32 and the terminal portion 40 from the front holding portion 52.

The front holding portion 52 has the shape of a plate extending along the extension 22 and in the vehicle width direction W.

The rear sections 41b of the two first connecting portions 41 are embedded in a rear surface 52b of the front holding portion 52.

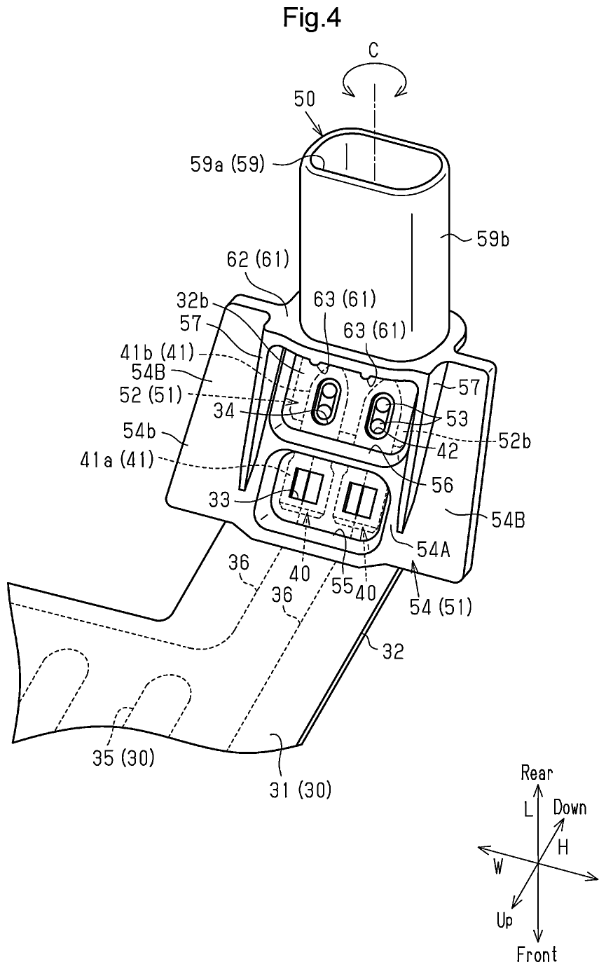

As shown in FIGS. 3 and 4, multiple protuberances 53 to be inserted into the two connection holes 42 are formed on the rear surface 52b of the front holding portion 52. In the present embodiment, two protuberances 53 are inserted into each connection hole 42 and are engaged with the inner surface of the connection hole 42. This prevents the terminal portions 40 from being displaced with respect to the terminal holding portion 51.

A part of the rear surface 52b of the front holding portion 52 that does not overlap with the two first connecting portions 41 is joined to the front surface 32f of the sheet extension 32.

As shown in FIGS. 2 and 3, the front holding portion 52, the front sections 41a of the two first connecting portions 41, and a part of the front surface 32f of the sheet extension 32 that does not overlap with the front holding portion 52 or the two first connecting portions 41 are all covered from the front by the extension 22. The front holding portion 52 and the sheet extension 32 are joined to the extension 22 at an interface with the extension 22.

As shown in FIGS. 3 to 6, the rear holding portion 54 has the shape of a plate extending along the extension 22 and in the vehicle width direction W.

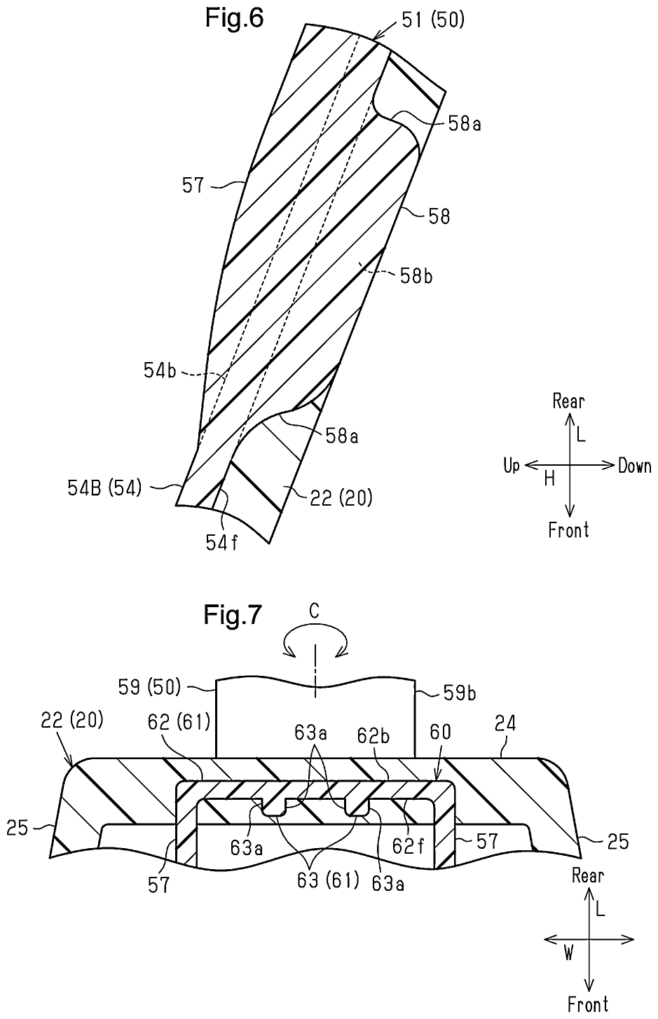

A part of the front surface 54f of the rear holding portion 54 that corresponds to a center portion 54A in the vehicle width direction W is joined to the rear surface 32b of the sheet extension 32 (see FIG. 3). In addition, sections of the front surface 54f corresponding to parts (hereinafter, referred to as side portions 54B) that extend from the center portion 54A toward the opposite sides in the vehicle width direction W are joined to the extension 22 (see FIG. 6).

As shown in FIGS. 3 and 4, the rear holding portion 54 includes two windows 55, 56 extending through the rear holding portion 54 in the thickness direction.

The window 55 surrounds both openings 33 and exposes the joints of the end portions 36 of the heating wire 35 and the front sections 41a of the first connecting portions 41 to the rear.

The window 56 surrounds both openings 34.

Water stop members (not shown) are attached to the windows 55, 56 to restrict water from entering the inside. Such water stop members are formed by, for example, filling the windows 55, 56 with a plastic.

As shown in FIG. 2, two side portions 54B extend from the center portion 54A to the two second wall portions 25 and are joined to the inner surfaces of the second wall portions 25.

As shown in FIGS. 4 to 6, the rear holding portion 54 includes first ribs 57, which project from the rear surface 54b, and second ribs 58, which project from the front surface 54f.

The first ribs 57 are each provided on one side of the windows 55, 56 in the vehicle width direction W (see FIG. 4).

Each second rib 58 is formed on the opposite side of the rear holding portion 54 from the corresponding first rib 57. The two second ribs 58 are embedded in the extension 22 (see FIG. 6). Specifically, in each of the second ribs 58, opposite end faces 58a in the longitudinal direction L and opposite end faces 58b in the vehicle width direction W are joined to the extension 22.

### Housing 59

As shown in FIGS. 2 to 5, the housing 59 has a tubular shape having a recess 59a that opens rearward. The term “tubular” here refers to a shape that extends circumferentially around the axis of the housing 59 and is not limited to a circular cross section. In other words, the cross-sectional shape of the housing 59 may include a circle, an ellipse, or a polygon with sharp or rounded corners, but is not restricted to these shapes. Due to the presence of the recess 59a, the rear end (first end) of the housing 59 is open. The housing 59 is integrally coupled to the rear end of the terminal holding portion 51. When the mating connector 14 is inserted into the recess 59a, the device 13 is electrically connected to the second connecting portions 43 of the terminal portions 40 extending into the recess 59a, and thus to the heater portion 30 (see FIG. 3). In the present embodiment, the axial direction along the axis of the housing 59 agrees with the longitudinal direction L.

As shown in FIGS. 2, 3, and 7, a part of the housing 59 that includes the front end (second end) is embedded in the first wall portion 24. Hereinafter, a part of the housing 59 that is embedded in the first wall portion 24 will be referred to as an embedded portion 60.

As shown in FIGS. 2 to 7, the embedded portion 60 includes a flange 61 projecting from an outer peripheral surface 59b of the housing 59.

The flange 61 includes a flange body 62, which extends over the entire housing 59 in a circumferential direction C of the housing 59, and protrusions 63, which protrude from the flange body 62.

As shown in FIGS. 2, 3, and 7, the opposite end faces (hereinafter referred to as a front surface 62f and a rear surface 62b) in the longitudinal direction L of the flange body 62 are joined to the first wall portion 24. An end face 62a in the radial direction of the flange body 62 is joined to the first wall portion 24 (see FIG. 3). The rear ends of the two first ribs 57 and the rear ends of the two side portions 54B are coupled to the flange body 62. This structure reinforces the flange body 62. Further, the rear ends of the two first ribs 57 and the rear ends of the two side portions 54B each form a part of the embedded portion 60. Specifically, the end faces in the circumferential direction C of the rear ends of the two first ribs 57 and the rear ends of the two side portions 54B are joined to the first wall portion 24.

The protrusions 63 protrude from the front surface 62f of the flange body 62. In the present embodiment, two protrusions 63 are provided between the two first ribs 57. Opposite end faces 63a in the circumferential direction C of each protrusion 63 are joined to the first wall portion 24.

In the present embodiment described above, the cover 12 is integrally formed by, for example, first joining the terminal portions 40 and the connector portion 50 to the heater portion 30. Then, the base 20 is insert molded by placing, as inserts, the heater portion 30, the terminal portions 40, and the connector portion 50 in the mold.

### Operation of the Present Embodiment

Operation of the present embodiment will now be described.

The embedded portion 60 of the housing 59, which is embedded in the first wall portion 24 of the base 20, includes the flange 61 as a projection. The front surface 62f and the rear surface 62b of the flange body 62 in the longitudinal direction L are joined to the first wall portion 24. Therefore, the stress acting in the longitudinal direction L on the interface between the embedded portion 60 and the base 20 is dispersed by providing the flange 61. Accordingly, when the load in the longitudinal direction L is applied to the housing 59, the housing 59 is unlikely to be detached from the base 20.

### Advantages of the Present Embodiment

The present embodiment has the following advantages.
(1) The cover 12 includes the heater portion 30, which includes the plastic sheet base 31 and the heating wire 35, the plastic connector portion 50, which is joined to the sheet base 31, and the plastic base 20, which is molded integrally with the heater portion 30 and the connector portion 50 by using the heater portion 30 and the connector portion 50 as inserts. The connector portion 50 includes the tubular housing 59, which has the open first end and the second end embedded in the first wall portion 24 of the base 20. The embedded portion 60 includes the flange 61 as a projection that projects from the outer peripheral surface 59b of the housing 59 and includes the front surface 62f and the rear surface 62b in the longitudinal direction L joined to the first wall portion 24.

This configuration operates in the above-described manner. Therefore, it is possible to prevent the connector portion 50 from being detached from the base 20.
(2) The projection is the flange 61, which has the flange body 62 extending over the entire housing 59 in the circumferential direction C.

This configuration increases the area of the interface between the first wall portion 24 of the base 20 and the flange body 62 at the front surface 62f and the rear surface 62b in the longitudinal direction L as compared with a case in which a projection is provided in a part in the circumferential direction C of the housing 59. This further disperses the stress acting in the longitudinal direction L on the interface between the embedded portion 60 and the base 20. Therefore, it is possible to reliably prevent the connector portion 50 from being detached from the base 20.
(3) The flange 61 includes the protrusions 63 as uneven portions that protrude from the front surface 62f of the flange body 62. The opposite end faces 63a in the circumferential direction C of the protrusion 63 are joined to the first wall portion 24 of the base 20.

When the mating connector 14 is inserted into the recess 59a of the housing 59, the flange 61 of the housing 59 may be detached from the base 20 if stress in the circumferential direction C acts on the interface between the flange 61 and the base 20. According to the above-described configuration, the flange 61 includes the protrusions 63. Therefore, the stress acting in the circumferential direction C is dispersed by the interface in the circumferential direction C between the protrusions 63 and the first wall portion 24 of the base 20. Accordingly, the flange 61 is unlikely to be detached from the first wall portion 24 of the base 20. Therefore, it is possible to more reliably prevent the connector portion 50 from being detached from the base 20.
(4) The cover 12 further includes the terminal portion 40 electrically connected to the heating wire 35. The connector portion 50 is integrally connected to the second end of the housing 59, and includes the terminal holding portion 51 for holding the terminal portion 40. The terminal holding portion 51 is joined to the extension 22 of the base 20.

When the mating connector 14 is connected to the housing 59, the terminal holding portion 51 may be detached from the base 20 if the stress resulting from the load applied to the housing 59 is concentrated on the interface between the terminal holding portion 51 and the base 20. In this case, the stress acts on the first connecting portions 41 of the terminal portions 40 and the heating wire 35 via the terminal holding portion 51. This may cause a breakage in the heating wire 35 or cracks in the connection between the end portions 36 of the heating wire 35 and the front sections 41a of the first connecting portions 41.

In this regard, according to the above-described configuration, the stress resulting from the load applied to the housing 59 is dispersed by the flange 61 of the housing 59. Accordingly, the terminal holding portion 51 is unlikely to be detached from the base 20. In other words, this configuration allows the terminal holding portion 51 to be reliably maintained in a supported state in the base 20. As a result, the above-mentioned stress is unlikely to be transmitted through the terminal holding portion 51 to the first connecting portions 41 of the terminal portions 40 and the heating wire 35. Therefore, this configuration effectively suppresses breakage of the heating wire 35 and the formation of cracks at the connection between the end portions 36 of the heating wire 35 and the front sections 41a of the first connecting portions 41.
(5) The rear holding portion 54 of the terminal holding portion 51 includes the second ribs 58, which project toward the extension 22 of the base 20 and are embedded in the extension 22.

With this configuration, the second ribs 58 of the rear holding portion 54 are embedded in the extension 22. Therefore, even when stress resulting from the load applied to the housing 59 acts on the interface between the terminal holding portion 51 and the base 20, the stress is dispersed at the interface between the second ribs 58 and the extension 22. Thus, the terminal holding portion 51 is unlikely to be detached from the base 20. This configuration allows the terminal holding portion 51 of the connector portion 50 to be reliably maintained in a supported state in the base 20. Therefore, it is possible to further reliably prevent the connector portion 50 from being detached from the base 20.
(6) The end faces in the circumferential direction C of the rear ends of the two first ribs 57 and the rear ends of the two side portions 54B are joined to the first wall portion 24.

With this configuration, the stress acting in the above-described circumferential direction C is dispersed by the interface in the circumferential direction C between the first wall portion 24 of the base 20 and the set of the two first ribs 57 and the two side portions 54B. Accordingly, the flange 61 is more unlikely to be detached from the first wall portion 24 of the base 20.

### Modifications

The above-described embodiment may be modified as follows. The above-described embodiment and the following modifications can be combined as long as the combined modifications remain technically consistent with each other.

The number and arrangement of the second ribs 58 are not limited to those in the above-described embodiment. For example, three or more second ribs 58 may be provided on the terminal holding portion 51, or only one second rib 58 may be provided. Further, the second ribs 58 may be provided on the front holding portion 52.

The second ribs 58 may be omitted.

The first ribs 57 may be omitted.

The shape of the terminal holding portion 51 is not limited to that in the above-described embodiment. For example, the rear ends of the two side portions 54B do not have to be connected to the flange body 62 or embedded in the first wall portion 24. In this case, the rear ends of the side portions 54B may be simply joined to the inner surface of the first wall portion 24 without being embedded in the first wall portion 24, or may be provided at a distance from the first wall portion 24 in the longitudinal direction L. Further, the side portion 54B is not limited to one that extends from the center portion 54A toward the opposite sides in the vehicle width direction W and are joined to the inner surface of the second wall portion 25. For example, a part of the side portion 54B may be embedded in the second wall portion 25.

The side portion 54B may be omitted, and the rear holding portion 54 may be formed only by the center portion 54A.

The terminal holding portion 51 may be omitted. In other words, the connector portion 50 may be formed only by the housing 59. This configuration is made by causing the connector portion 50 to hold the terminal portion 40.

The number of the protrusions 63 is not limited to two as described in the above-described embodiment. For example, three or more protrusions 63 may be provided, or only one protrusion 63 may be provided.

The arrangement of the protrusions 63 is not limited to the arrangement in which the protrusions 63 are provided only between the two first ribs 57 as illustrated in the above-described embodiment. For example, multiple protrusions 63 may be arranged in the circumferential direction C at equal intervals over the entire flange 61. Further, the protrusions 63 are not limited to those provided on the front surface 62f of the flange body 62, and may be provided on the rear surface 62b or the end face 62a of the flange body 62.

The uneven portions according to the present disclosure are not limited to the protrusions 63 protruding from the flange body 62 as illustrated in the above-described embodiment, and may be a recess formed in the flange body 62. In this case, the recess may be formed in the front surface 62f or the rear surface 62b of the flange body 62, or may be formed in the end face 62a.

The projection according to the present disclosure is not limited to the one having the flange body 62 extending over the entire circumference of the housing 59 like the flange 61 illustrated in the above-described embodiment. For example, the projection may be provided in a part of the housing 59 in the circumferential direction C. Specifically, multiple protrusions on the outer peripheral surface 59b of the housing 59 may be arranged at intervals in the circumferential direction C.

The plastics forming the base 20, the sheet base 31 of the heater portion 30, and the connector portion 50 are not limited to the combinations described in the above-described embodiment (ABS plastic for the base 20, ABS plastic for the sheet base 31, AES plastic for the connector portion), and may be changed in consideration of the degree of surface contact with the base 20.

The radar device 11 is not limited to one that transmits and receives millimeter waves as described in the above-described embodiment, and may be one that transmits and receives near-infrared rays, for example. In this case, the cover 12 may have near-infrared ray transparency.

The vehicle exterior component according to the present disclosure is not limited to a component that forms the outer shell of the vehicle 10 in the front portion of the vehicle 10, and the arrangement may be changed as long as the vehicle exterior component is arranged in front of the radar device 11 in the emission direction of the electromagnetic waves of the radar device 11. In this case, the vehicle exterior component may form the outer shell of the rear portion of the vehicle 10, such as a rear bumper, or may form the outer shell of a side portion of the vehicle 10, such as a side decorative component.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a heater portion that includes:
a sheet base made of a plastic; and
a heating wire that is held by the sheet base and generates heat when energized;
a connector portion made of a plastic, the connector portion being joined to the sheet base; and
a base made of a plastic, the base being molded integrally with the heater portion and the connector portion by using the heater portion and the connector portion as inserts, wherein
the connector portion includes a tubular housing having an open first end and a second end that is embedded in the base,
a direction along an axis of the housing is defined as an axial direction of the housing, and
a part of the housing that is embedded in the base includes a projection that projects from an outer peripheral surface of the housing, end faces on one side and an other side of the projection in the axial direction being joined to the base.

2. The vehicle exterior component according to claim 1, wherein
a circumferential direction of the housing is referred to as a circumferential direction, and
the projection is a flange extending over the entire housing in the circumferential direction.

3. The vehicle exterior component according to claim 2, wherein
the flange includes:
a flange body extending over the entire housing in the circumferential direction; and
an uneven portion in part of the flange body, the uneven portion being a recess or a protrusion, and
an end face in the circumferential direction of the uneven portion is joined to the base.

4. The vehicle exterior component according to claim 1, further comprising a terminal portion electrically connected to the heating wire, wherein
the connector portion includes a terminal holding portion that is integrally coupled to the second end of the housing and holds the terminal portion, and
the terminal holding portion is joined to the base.

5. The vehicle exterior component according to claim 4, wherein the terminal holding portion includes a rib that projects toward the base and is embedded in the base.
